(19) United States
(12) Patent Application Publication
(10) Pub. No.: US 2026/0300641 A1
(43) Pub. Date: Oct. 1, 2026

(54) SYSTEM FOR GENERATING AN AGENTIC SYSTEM

(71) Applicant: Microsoft Technology Licensing, LLC, Redmond, WA (US)

(72) Inventors: Cong CHEN, Sammamish, WA (US); Sheikh Sadid Al HASAN, Weymouth, MA (US); Zhiyong HU, Natick, MA (US); Youjiang WU, Seattle, WA (US); Vivek GUPTA, Groton, MA (US); Xiangyang CAO, Snohomish, WA (US); Yaron Katriel STERNBERG, Brooklyn, NY (US); Hamsa SHANKAR, Redmond, WA (US); Kexuan CAI, Redmond, WA (US); Alexander Z MOYSE, Stow, MA (US); Somya SHARMA, Bellevue, WA (US)

(73) Assignee: Microsoft Technology Licensing, LLC, Redmond, WA (US)

(21) Appl. No.: 19/092,872

(22) Filed: Mar. 27, 2025

(51) Int. Cl. G06F 40/40; G06N 3/0475

(52) U.S. Cl. CPC G06F 40/40; G06N 3/0475

(57) ABSTRACT

A system is provided for generating an agentic system. The system receives a request including natural language text input from an interaction interface, generates an agent design prompt including an agent task description, agent output instructions, and scored agents based on the request, and inputs the agent design prompt into an agent design generator to generate one or more agents. A tool design prompt is generated to include the one or more generated agents, a tool task description, tool output instructions, and scored tools. The tool design prompt is then inputted into a tool generator to generate one or more tools, and the system generates and outputs the agentic system including the one or more generated agents and the one or more generated tools.

### BACKGROUND

In large-scale computational environments where large amounts of data are generated, complex data analysis can be time-intensive and often requires specialized data science knowledge. The use of machine learning models is a promising approach to automate large-scale data analysis. However, a key challenge that persists in the realm of large language models is their limitation in specialized analytic tasks. While large language models excel at producing text that is coherent and contextually relevant, they often struggle to perform tasks that require domain-specific analytic expertise or actions.

One approach for automating large-scale data analysis is to divide the analytic task into multiple sub-tasks, and delegating these sub-tasks to a plurality of agents and tools, which are software modules configured to handle specific domains of tasks or requests that directly align with their areas of expertise. These agents and tools may be interconnected to form an agentic system. However, writing code for an agentic system may be challenging, especially when the agents and tools are strictly evaluated for accuracy and latency, and the behaviors of the agents and tools are sensitive to even small changes in the written code. Moreover, manually designing the agentic system and typing the code for each of the agents and tools in the agentic system is time-intensive, costly, and inefficient.

### SUMMARY

To address the above issues, a computing system is provided for generating an agentic system. According to one aspect, the computing system includes processing circuitry and memory storing instructions that, when executed by the processing circuitry, cause the processing circuitry to receive a request including natural language text input from an interaction interface, generate an agent design prompt including an agent task description, agent output instructions, and scored agents based on the request, and input the agent design prompt into an agent design generator to generate one or more agents. A tool design prompt is generated to include the one or more generated agents, a tool task description, tool output instructions, and scored tools. The tool design prompt is then inputted into a tool generator to generate one or more tools, and the system generates and outputs the agentic system including the one or more generated agents and the one or more generated tools.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to one example implementation.

FIG. 2 is a schematic view showing examples of the agent design prompt and tool design prompt of the computing system of FIG. 1.

FIG. 3 is a schematic view showing examples of the critic prompts of the computing system of FIG. 1.

FIG. 4 is a schematic view showing an example of the adaptive agent archive of the computing system of FIG. 1.

FIG. 5 is a schematic view showing an example of the scored agents of the adaptive agent archive of the computing system of FIG. 1.

FIG. 6 is a schematic view showing an example of the scored tools of the adaptive agent archive of the computing system of FIG. 1.

FIG. 7 is a schematic view showing an exemplary implementation of the agentic system generated by the computing system of FIG. 1

FIG. 8 shows a flowchart for a method for generating an agentic system according to one example implementation.

FIG. 9 shows a schematic view of an example computing environment in which the computing system of FIG. 1 may be enacted.

### DETAILED DESCRIPTION

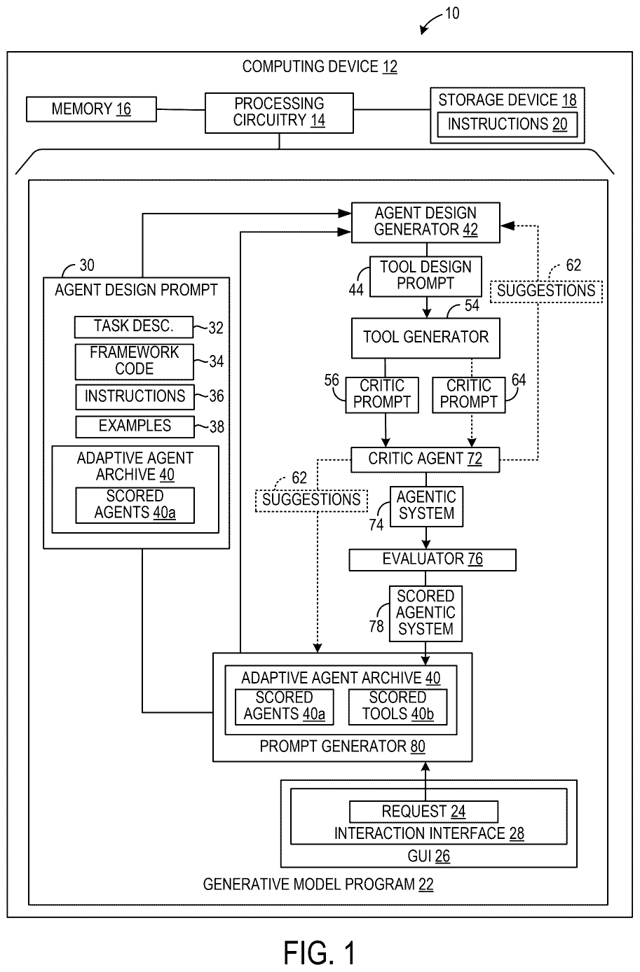

To address the issues described above, FIG. 1 illustrates a schematic view of a computing system 10 for generating an agentic system 78 according to a first example implementation. The computing system 10 includes a computing device 12 having processing circuitry 14, memory 16, and a storage device 18 storing instructions 20. In this first example implementation, the computing system 10 takes the form of a single computing device 12 storing instructions 20 in the storage device 18, including a generative model program 22 that is executable by the processing circuitry 14 to perform various functions including an agent design generator 42, a tool generator 54, a critic agent 72, an evaluator 76, and a prompt generator 80.

The agent design generator 42, the tool generator 54, the critic agent 72, the evaluator 76, and the prompt generator 80 may be configured as trained generative models. For the sake of clarity, the trained generative models 42, 54, 72, 76, and 80 will be henceforth referred to as a trained generative language models. However, it will be noted that the term ‘trained generative language model’ is merely illustrative, and the underlying concepts encompass a broader range of generative models, including multi-modal models, diffusion models, and generative adversarial networks, which may receive text, image, and/or audio inputs and generate text, image, and/or audio outputs, as discussed in further detail below.

In general, the processing circuitry 14 may be configured to receive, via the interaction interface 28 (in some implementations, the interaction interface API), a request 24 including natural language text input, which is incorporated into an agent design prompt 30 by the prompt generator 80. In some instances, the interaction interface 28 may be a portion of a graphical user interface (GUI) 26 for accepting user input and presenting information to a user.

In other instances, the interaction interface 28 may be presented in non-visual formats such as an audio interface for receiving and/or outputting audio, such as may be used with a digital assistant. In yet another example the interaction interface 28 may be implemented as an interaction interface application programming interface (API). In such a configuration, the input to the interaction interface 28 may be made by an API call from a calling software program to the interaction interface API, and output may be returned in an API response from the interaction interface API to the calling software program. The API may be a local API or a remote API accessible via a computer network such as the Internet. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the interaction interface API (for example, interaction interface 28), so that the processing circuitry 14 is configured to interface with the interaction interface 28 that receives input of the request 24 including natural language text input and, in response, generates a scored agentic system 78.

The trained generative language model is a generative model that has been configured through machine learning to receive input that includes natural language text and generate output that includes natural language text in response to the input. It will be appreciated that the trained generative language model can be a large language model (LLM) having tens of millions to billions of parameters, non-limiting examples of which include GPT-3, BLOOM, and LLaMa-2. The trained generative language model can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-2 and GPT-4 VISUAL. Further, the trained generative language model can be configured to have a generative pre-trained transformer architecture, examples of which are used in the GPT-3 and GPT-4 models. Additionally, the trained generative language model can be a reasoning model such as o1, o1-mini, o3, or o3-mini.

The prompt generator 80 is configured to generate an agent design prompt 30 including an agent task description 32, framework code 34, agent output instructions 36, examples 38, and scored agents 40a from an adaptive agent archive 40, based on the request 24. The scored agents 40a may be a predetermined number of top scoring agents 40a in the adaptive agent archive 40. The framework code 34 may include code instructing how the agents 40a are to be initialized and called. Functions of the agents 40a may be defined as methods in the framework code 34. The framework code 34 may be encoded in Python or Java, for example. The agent output instructions 36 may specify the capabilities and controls of the one or more agents to be generated. The agent design prompt 30 is subsequently inputted into the agent design generator 42 to generate one or more agents. The agent design generator 42 receives the agent design prompt 30 and generates a tool design prompt 44

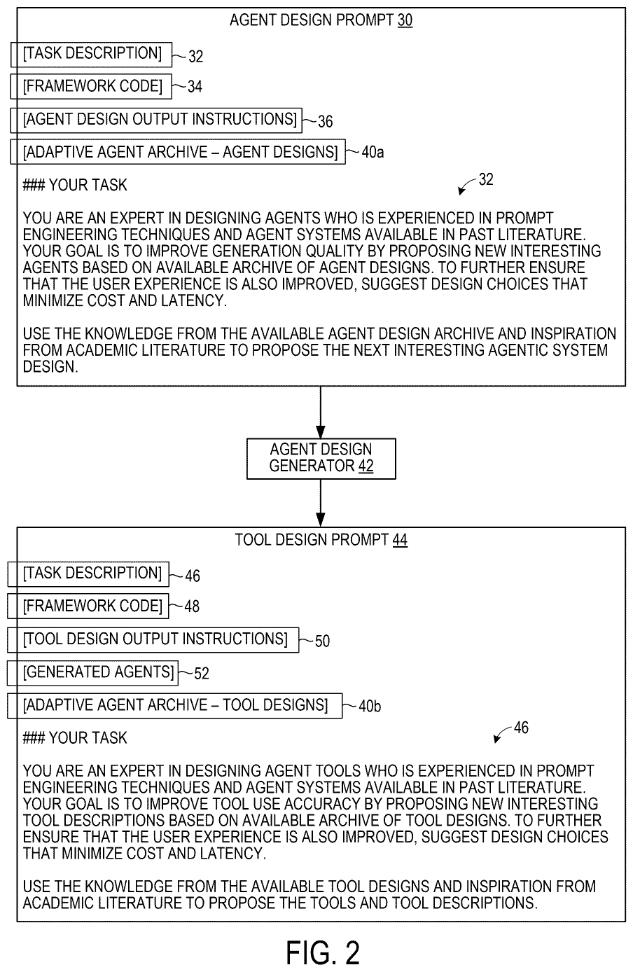

Turning to FIG. 2, examples of the agent design prompt 30 and the tool design prompt 44 are shown. In these examples, the agent design prompt 30 includes a section for the agent task description 32, which indicates that the goal is to propose “new interesting agents based on available archive of agent designs” while minimizing cost and latency. The framework code 34 may indicate that the agents are to be coded in Python. The agent design prompt 30 also includes agent output instructions 36 and scored agent designs 40a from an adaptive agent archive 40. The agent design generator 42 generates one or more agents 52 and the tool design prompt 44 based on the agent design prompt 30.

The tool design prompt 44 includes the one or more generated agents 52, a tool task description 46, framework code 48, tool design output instructions 50, and scored tools designs 40b from the adaptive agent archive 40. The scored tools 40b may be a predetermined number of top scoring tools 40b in the adaptive agent archive 40. The tool task description 46 indicates that the goal is to “improve tool use accuracy by proposing new interesting tool descriptions based on the available archive of tool designs” while minimizing cost and latency.

Returning to FIG. 1, the tool generator 54 receives the tool design prompt 44 as input and generates and allocates relevant tools based on the tool design prompt 44. The tool generator 54 generates a first critic prompt 56 which includes the generated tools and the generated agents. The first critic prompt 56 is inputted into a critic agent 72, which evaluates the generated tools and the generated agents for code execution errors, and generates one or more suggestions 62 to resolve identified code execution errors. The critic agent 72 determines whether to regenerate the one or more tools and the one or more agents. The predetermined criteria used to make this determination may be the number of critic prompts used or a content of the one or more suggestions, for example.

When the critic agent 72 determines that the one or more tools and the one or more agents are to be regenerated, in a subsequent iterative round, the critic agent 72 causes the prompt generator 80 to regenerate the agent design prompt including the one or more suggestions, the agent task description, the agent output instructions, and the scored agents. The critic agent 72 also causes the agent design generator 42 to regenerate the tool design prompt 44 including the one or more generated agents, the one or more suggestions 62, the tool task description, the tool output instructions, and the scored tools 40b. The tool generator 54 receives the tool design prompt 44 to generate a second critic prompt 64 including the one or more agents and the one or more tools regenerated in the subsequent iterative round.

When the critic agent 72 determines not to regenerate the one or more tools and the one or more agents, the critic agent 72 proceeds to generate an agentic system 74 including the one or more generated agents and the one or more generated tools.

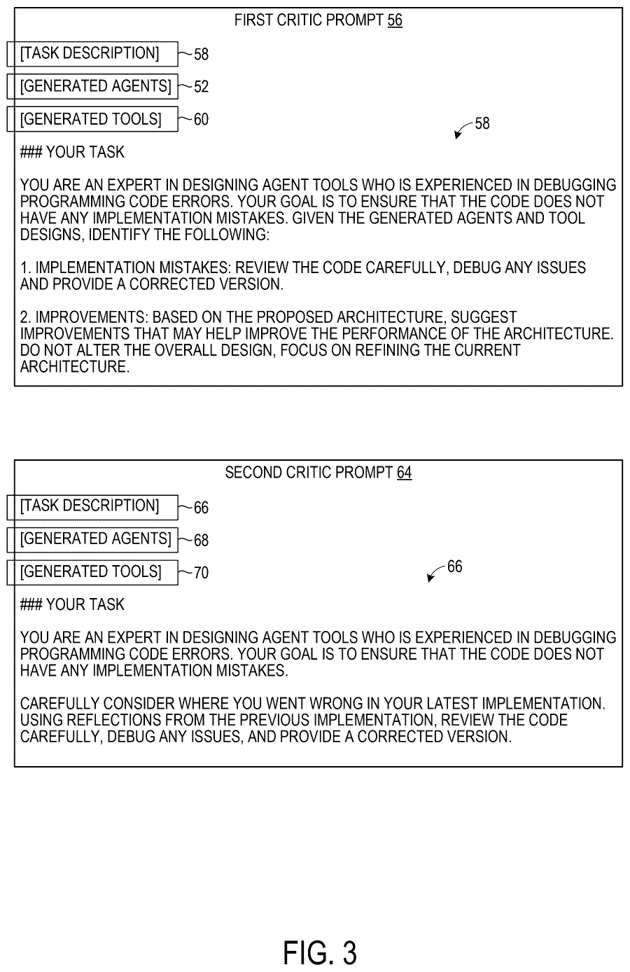

Turning to FIG. 3, examples of the first critic prompt 56 generated in a first iterative round and the second critic prompt 64 generated in a subsequent iterative round are depicted. In this example, the first critic prompt 56 includes a critic task description 58 as well as agents 52 and tools 60 that were generated in the first iterative round. The critic task description 58 instructs the critic agent 72 to review the code for the agents and tools and debug any issues to provide a corrected version, making sure the code does not have any implementation mistakes, as well as suggest improvements. The second critic prompt 64 includes a critic task description 66 as well as agents 68 and tools 70 generated in the subsequent iterative round. Like the first critic prompt 56, the critic task description 66 of the second critic prompt 64 instructs the critic agent 72 to review the code for the agents and tools to make sure there are no implementation mistakes. However, the critic task description 66 also includes instructions to “carefully consider where you went wrong in your latest implementation”.

Returning to FIG. 1, the agentic system 74 outputted by the critic agent 72 is inputted into an evaluator 76, which generates an evaluation for the agentic system 74. The evaluation may be assigned for the agentic system 74, and/or evaluations may be assigned for each agent and tool in the agentic system 74. The evaluator 76 determines whether the evaluation of the agentic system 74 meets predetermined evaluation criteria, which may include predetermined thresholds for quantitative evaluation scores or a number of iterations reached in generating the agentic system 74, for example.

When the evaluator 76 determines that the evaluation for the agentic system 74 does not meet the predetermined evaluation criteria, the evaluator 76 causes the prompt generator 80 to regenerate the agent design prompt 30 including the generated evaluation, the agent task description 32, the agent output instructions 36, and the scored agents 40a, and the agent design prompt 30 is inputted into the agent design generator 42 to regenerate the one or more agents.

When the evaluator 76 determines that the evaluation for the agentic system meets the predetermined evaluation criteria, the evaluator 76 proceeds to output the agentic system 74 and incorporate the agentic system 74 into an adaptive agent archive 40 comprising scored agents 40a and scored tools 40b. The adaptive agent archive 40 may include historical versions of the agentic system 74. The adaptive agent archive 40 may rank agents 40a and tools 40b from lowest to highest in accordance with quantitative evaluations assigned by the evaluator 76.

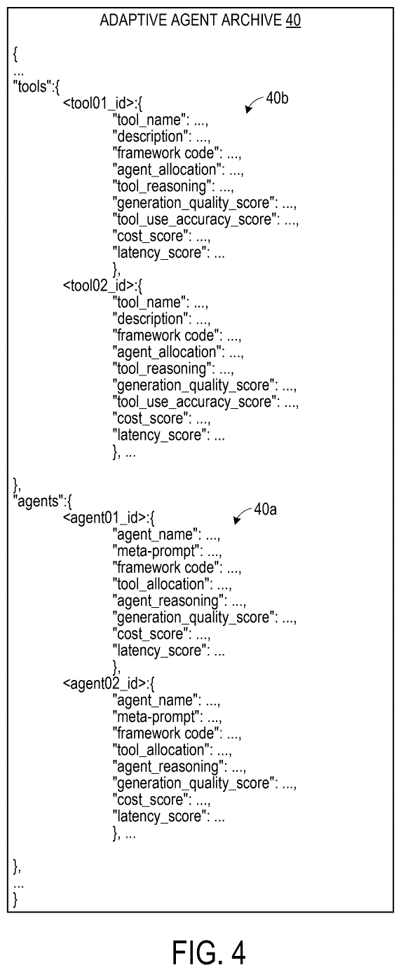

Turning to FIG. 4, an example of the adaptive agent archive 40 is depicted. In this example, the scored agents 40a and the scored tools 40b are formatted in a JSON structure to list properties for each scored agent 40a and scored tool 40b. Each scored agent 40a may have properties including agent name, meta-prompt (the agent design prompt used to generate the agent), framework code (the computer-executable code for the agent), tool allocation (tools associated with the agent), agent reasoning (the reasoning for generating the agent), and evaluation scores (generation quality score, tool use accuracy score, cost score, and latency score). Each scored tool 40b may have properties including tool name, tool description, framework code (the computer-executable code for the tool), agent allocation (agents associated with the tool), tool reasoning (the reasoning for generating the tool), and evaluation scores (generation quality score, cost score, and latency score). These properties may be defined in key-value pairs, for example.

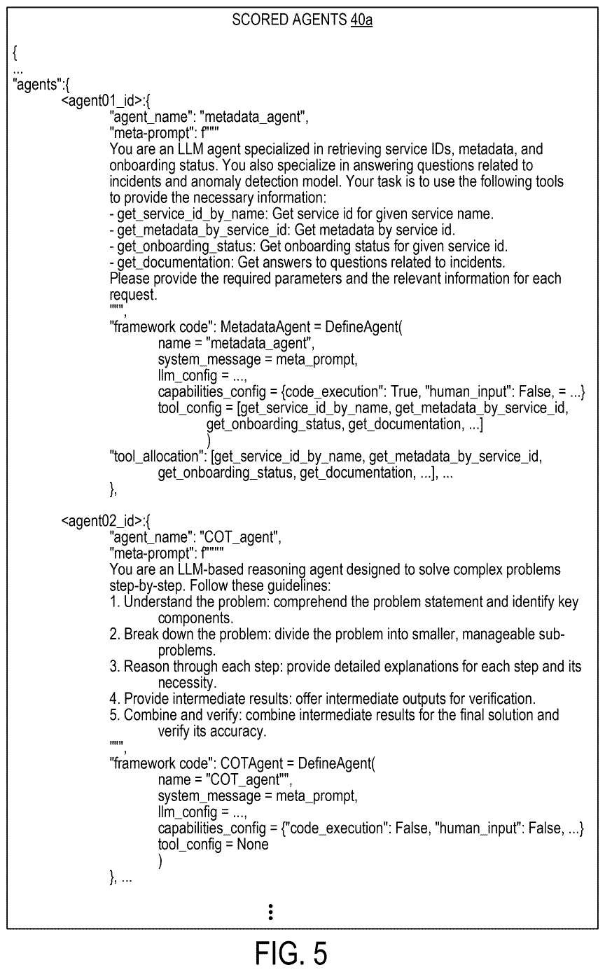

Turning to FIG. 5, examples of the agents 40a that may be included in the adaptive agent archive 40 are depicted. The agents 40a are configured to perform tasks and/or retrieve information in specialized domains. The agents 40a may be instantiated as specialized software modules configured to handle specific domains of tasks or requests that directly align with their areas of expertise. The agents 40a may be generative modules configured with specialized algorithms or processing capabilities to execute specific tasks in various specialized domains. The agents 40a may operate in either an autonomous or consensus-driven mode. In an autonomous mode, the agents 40a may work independently and uncoordinated with one another. In a consensus-driven mode, the agents 40a may collaborate and arrive at a decision based on collective intelligence.

In FIG. 5, the agents 40a include a metadata agent and a chain-of-thought agent. However, the functionalities of the agents 40a are not particularly limited, and may also include a debate agent, a root cause analysis agent, a self-refinement agent, for example. The meta-prompt for the metadata agent instructs the agent to retrieve the service ID for a given service name, retrieve metadata by service ID, retrieve an onboarding stats for a given service ID, and obtain answers to questions related to incidents. The framework code for the metadata agent includes configurations and executable code for running the metadata agent.

The meta-prompt for the chain-of-thought agent instructs the agent to understand a problem, break down the problem into sub-problems, reason through each step, provide intermediate results, and combine the intermediate results for the final solution and verify its accuracy.

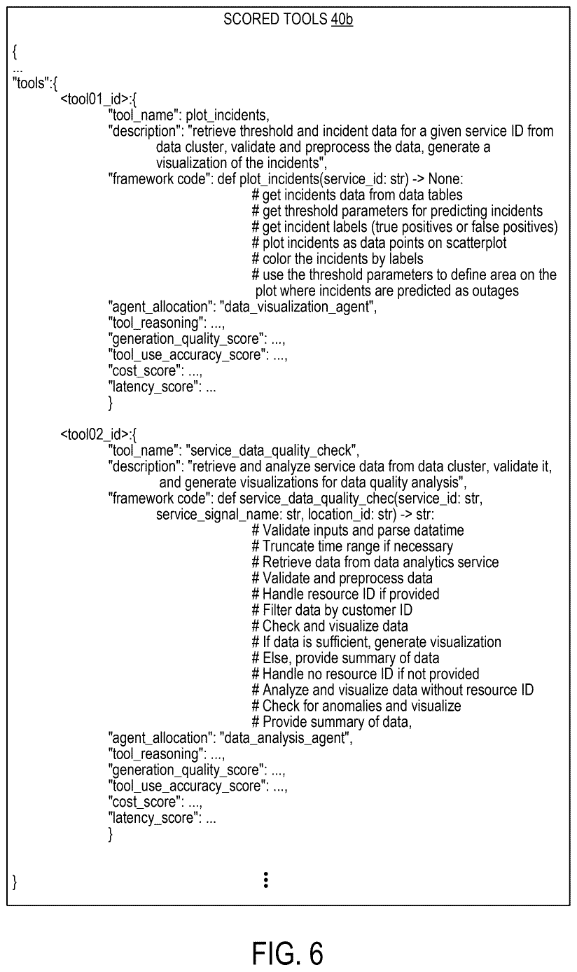

Turning to FIG. 6, examples of tools 40b that may be included in the adaptive agent archive 40 are depicted. In FIG. 6, the tools 40b include an incident plotter and a service data quality checker. However, the functionalities of the tools 40b are not particularly limited, and may also include a root cause analysis tool, a data retrieval tool, or a visualization tool, for example. The incident plotter is configured to retrieve threshold and incident data for a given service ID from a data cluster, validate and preprocess the data, and generate a visualization of the incidents. The framework code for the incident plotter includes computer-executable code for executing discrete steps including obtaining historical incidents data from data tables. The historical incidents data may include past incidents meta-data including the duration of the incident, time of the incident, resources affected, incident priority classification, and incident prediction labels provided by the anomaly detection model. The incident labels may either be true positive or false positive. A true positive label suggests that the incident was a true outage incident and was also classified as an outage incident by the anomaly detection model. A false positive label suggests that an incident was incorrectly classified as an outage incident.

The incident plotter further retrieves threshold parameters for predicting outages for a given service. These threshold parameters may be custom defined for each service to define how to classify an outage in the anomaly detection model. For instance, the parameters may be in the form of the thresholds for duration of incident and the number of resources affected. Incidents exceeding these threshold values may be classified as outages.

After the required data is retrieved, the incident plotter may pre-process the incident labels for plotting. The incident labels are used to label and color individual incident data points in the plot.

The incident plotter may generate a scatterplot which plots the incidents as data points for a given service. The x-axis and y-axis may be used to plot the data points represent the number of resources affected and duration of the incident, respectively. Threshold parameters for the number of resources affected and the duration of incidents may be used to plot a vertical line and a horizontal line, respectively, to define an area on the plot where incidents are predicted as outages. The area representing exceeded thresholds may be colored as light red to represent an area where the anomaly detection model classifies incidents as outages. Any red data points in the light red colored area may provide insights into how the threshold parameters may be fine-tuned to further minimize the number of false positives.

The service data quality checker is configured to retrieve and analyze service data from a data cluster, validate the service data, and generate visualizations for data quality analysis. The framework code for the service data quality checker includes computer-executable code for executing discrete steps including validating inputs and parsing the time variable, truncating the time range if necessary, retrieving data from data analytics, validating and preprocessing data, handling resource ID if provided, filtering data by customer ID, and checking and visualizing data.

When the data is determined to be sufficient, the visualization is generated. Otherwise, the summary of the service level data is provided. The service data quality checker handles instances where no resource ID is provided, analyzing and visualizing data without a resource ID. The service data quality checker also checks for anomalies and visualizes the data as line plots and box plots.

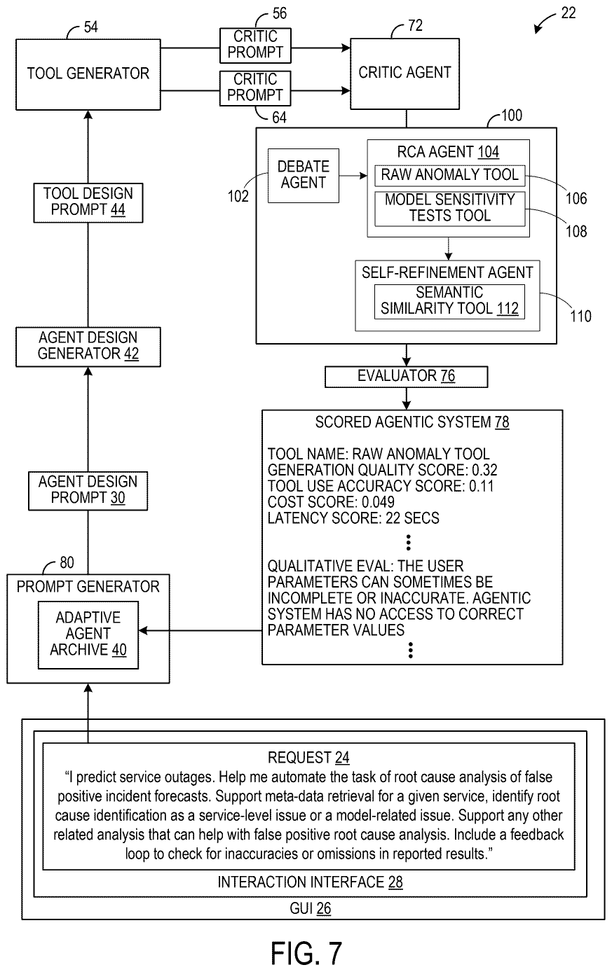

Referring to FIG. 7, one exemplary implementation illustrates the agentic system 100 generated by the critic agent 72, along with the corresponding evaluations generated by the evaluator 76. A user inputs a request 24 asking for help in automating the task of root cause analysis of false positive incident forecasts. The requests 24 outlines the desired functionality of the agentic system 100, including support for meta-data retrieval for a given service, identification of root cause identification as a service-level issue or a model-related issue, and a feedback loop to check for inaccuracies or omissions in reported results. In response, the agent design generator 42 generates the debate agent 102, root cause analysis agent 104, and self-refinement agent 110. The tool generator 54 generates a raw anomaly tool 106, a model sensitivity tests tool 108, and semantic similarity tool 112. The critic agent 72 generates an agentic system 100 including the agents 102, 104, 110 and tools 106, 108, 112 generated by the agent design generator 42 and the tool design generator 54, respectively.

The agentic system 100 accepts a user query related to investigating the root cause of why false positive incidents are being reported in a service. The user query specifies a service ID to identify the service to be analyzed. The debate agent breaks down the user query into smaller problems. The root cause analysis agent 104 identifies smaller tasks to perform, including identifying raw anomalies using the raw anomaly tool 106, and varying model parameters and thresholds using the model sensitivity tests tool 108, simulating the model that was responsible for generating the false positive incidents. The root cause analysis agent 104 subsequently generates data analysis and root cause label and reasoning, which is inputted into the self-refinement agent 110 which performs several steps of refinement, checking for inaccuracies in the output of the root cause analysis agent 104. To check for inaccuracies, the self-refinement agent 110 uses the semantic similarity tool 112 to compare the semantic similarity of the output of the root cause analysis agent 104 to the outputs of the raw anomaly tool 106 and the model sensitivity tests tool 108 registered with the root cause analysis agent 104. Based on the determined semantic similarity between of the output of the root cause analysis agent 104 to the outputs of the tools 106, 108, the self-refinement agent 110 adds back information or removes inaccuracies, then generates and outputs a response to the user.

The evaluator 76 generates an evaluation for the generated agentic system 100. The evaluation may include qualitative and/or quantitative evaluations. In this example, the evaluator 76 assigns quantitative scores for each tool and agent in the generated agentic system 100. For example, the raw anomaly tool 106 is assigned a generation quality score of 0.32, a tool use accuracy score of 0.11, a cost score of 0.049, and a latency score of 22 seconds. A qualitative evaluation is assigned for the whole agentic system 100. In this example, the qualitative evaluation indicates that the user parameters can be incomplete or inaccurate, and the agentic system has no access to correct parameter values. The evaluator 76 incorporates the evaluation into the agentic system 100 to generate a scored agentic system 78, which may be added into the adaptive agent archive 40 and incorporated by the prompt generator 80 into the agent design prompt 30 and into the tool design prompt 44 by the agent design generator 42 in subsequent iterative rounds for regenerating the agents and tools of the agentic system 100, so that the agentic system 100 may evolve and undergo refinement in multiple iterative rounds of agent and tool generation.

The adaptive agent archive 40 may include generic agents 40a with no additional tool allocations or capabilities as well as specialist, domain-specific agents 40a with specialized tool allocations and/or capabilities. In subsequent iterative rounds of agent and tool generation, additional tool allocations and/or capabilities may be added to the generic agents 40a. For example, the chain-of-thought agent of FIG. 5 may be modified in subsequent iterative rounds to have additional tool allocations and capabilities to obtain more context of task descriptions. The metadata agent of FIG. 5 may be revised in subsequent iterative rounds to have tool allocations and capabilities which combine reasoning and specialist functionalities.

The evaluator 76 may use an objective function ( [symbol] ) represented as [symbol] =λ_{G}L_{G}+λ_{T}L_{T}+λ_{C}L_{C}+λ_{L}L_{L}.

Here, the λ coefficients scale the individual loss terms. L_{C} and L_{L} are temperature-scaled cost and latency of the running inference with the generated agentic system 100. L_{G} is the generation quality and L_{T} is the tool use accuracy. L_{T} is measured by comparing the predicted tool against the ground truth tool that may be obtained from benchmark dataset. On the other hand, L_{G} includes both reference-based and reference-free metrics to evaluate the quality of the response generated by the agentic system 100.

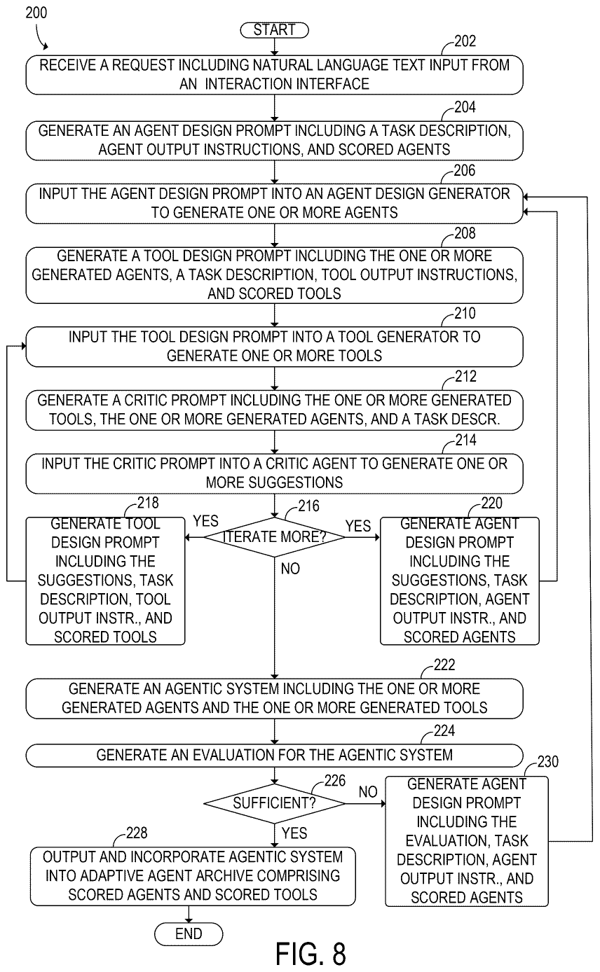

FIG. 8 is a flowchart that illustrates a method 200 for designing an agentic system according to one example. The method 200 may be implemented on the computing system 10 illustrated in FIG. 1 above.

At step 202, the method 200 includes receiving a request including natural language text input from an interaction interface. At step 204, the method 200 includes generating an agent design prompt including an agent task description, agent output instructions, and scored agents, based on the request. At step 206, the method 200 includes inputting the agent design prompt into an agent design generator to generate one or more agents.

At step 208, the method 200 includes generating a tool design prompt including the one or more generated agents, a tool task description, tool output instructions, and scored tools. At step 210, the method 200 includes inputting the tool design prompt into a tool generator to generate one or more tools.

At step 212, the method 200 includes generating a critic prompt including the one or more generated tools, the one or more generated agents, and a critic task description. At step 214, the method 200 includes inputting the critic prompt into a critic agent to generate one or more suggestions.

At step 216, it is determined whether steps 206-214 will be iterated once more to regenerate the one or more agents and the one or more tools. The predetermined criteria used to make this determination may be the number of critic prompts used or a content of the one or more suggestions, for example.

When it is determined at step 216 that steps 206-214 will be iterated once more, steps 218 and 220 of method 200 are performed. Method 200 proceeds to step 218 of regenerating the tool design prompt including the one or more suggestions, the tool task description, tool output instructions, and scored tools, and the method 200 further proceeds to step 210 of inputting the tool design prompt into the tool generator to regenerate the one or more tools. Method 200 also proceeds to step 220 of regenerating the agent design prompt including the one or more suggestions, the agent task description, the agent output instructions, and the scored agents, and method 200 further proceeds to step 206 of inputting the agent design prompt into the agent design generator to regenerate the one or more agents.

When it is determined at step 216 that steps 206-214 will not be iterated once more, method 200 proceeds to step 222 to generate an agentic system including the one or more generated agents and the one or more generated tools. Then ate step 224, an evaluation is generated for the agentic system.

At step 226, it is determined whether the evaluation for the agentic system meets predetermined evaluation criteria. The predetermined evaluation criteria may include predetermined thresholds for quantitative evaluation scores or a number of iterations reached in generating the agentic system, for example.

When it is determined at step 226 that the evaluation for the agentic system does not meet the predetermined evaluation criteria, the method 200 proceeds to step 230 to regenerate the agent design prompt including the generated evaluation, the agent task description, the agent output instructions, and the scored agents, and method 200 further proceeds to step 206 of inputting the agent design prompt into the agent design generator to regenerate the one or more agents.

When it is determined at step 226 that the evaluation for the agentic system meets the predetermined evaluation criteria, the method 200 proceeds to step 228 to output the agentic system and incorporate the agentic system into an adaptive agent archive comprising scored agents and scored tools.

The above-described system and method automate the generation of agentic systems including one or more generated agents and one more generated tools, harnessing the capabilities of language models to generate computer-executable code for the agents and tools based on natural language user prompts. A generative process incorporates evaluations and feedback to generate agents and tools in iterations, thereby increasing the quality of the generated agents and tools. Accordingly, cost and latency may be minimized, and accuracy scores increased.

Furthermore, the incorporation of an archive of agents and tools into the prompts for the language models leverages previously generated agents and tools in the generation of new agents and tools. The encoding of the archive in computer-executable code rather than in graph form may ensure that the prompt incorporates examples of previously generated computer-executable code to guide the generation of new agents and tools in useful directions.

In some embodiments, the methods and processes described herein may be tied to a computing system of one or more computing devices. In particular, such methods and processes may be implemented as a computer-application program or service, an API, a library, and/or other computer-program product.

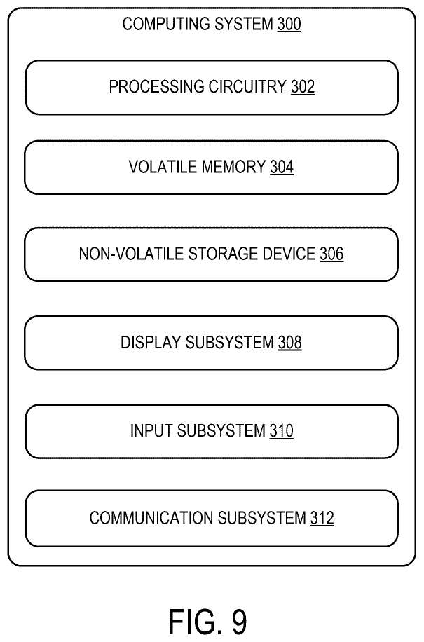

FIG. 9 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (for example, smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 9.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of aspects of the present disclosure. One aspect provides a computing system for generating an agentic system, the computing system comprising processing circuitry and memory storing instructions that, when executed by the processing circuitry, cause the processing circuitry to receive a request including natural language text input from an interaction interface, generate an agent design prompt including an agent task description, agent output instructions, and scored agents based on the request, input the agent design prompt into an agent design generator to generate one or more agents, generate a tool design prompt including the one or more generated agents, a tool task description, tool output instructions, and scored tools, input the tool design prompt into a tool generator to generate one or more tools, and generate and output the agentic system including the one or more generated agents and the one or more generated tools. In this aspect, additionally or alternatively, the instructions may be further configured to be executed to generate a critic prompt including the one or more generated agents, the one or more generated tools, and a critic task description, and to input the critic prompt into a critic agent to generate one or more suggestions. In this aspect, additionally or alternatively, the instructions may be further configured to be executed to determine whether to regenerate the one or more agents and the one or more tools based on predetermined criteria. In this aspect, additionally or alternatively, the predetermined criteria may be selected from the group consisting of a number of critic prompts used, and a content of the one or more suggestions. In this aspect, additionally or alternatively, upon determining to regenerate the one or more agents and the one or more tools, the instructions may be further configured to be executed to regenerate the tool design prompt including the one or more suggestions, the tool task description, the tool output instructions, and the scored tools, and input the tool design prompt into the tool generator to regenerate the one or more tools, and regenerate the agent design prompt including the one or more suggestions, the agent task description, agent output instructions, and the scored agents, and input the agent design prompt into the agent design generator to regenerate the one or more agents. In this aspect, additionally or alternatively, the instructions may be further configured to be executed to generate an evaluation for the agentic system, and determine whether the evaluation for the agentic system meets predetermined evaluation criteria. In this aspect, additionally or alternatively, the predetermined evaluation criteria may include predetermined thresholds for quantitative evaluation scores or a number of iterations reached in generating the agentic system. In this aspect, additionally or alternatively, upon determining that the evaluation for the agentic system does not meet the predetermined evaluation criteria, the instructions may be further configured to be executed to regenerate the agent design prompt including the generated evaluation, the agent task description, the agent output instructions, and the scored agents, and input the agent design prompt into the agent design generator to regenerate the one or more agents. In this aspect, additionally or alternatively, upon determining that the evaluation for the agentic system meets the predetermined evaluation criteria, the instructions may be further configured to output the agentic system and incorporate the agentic system into an adaptive agent archive comprising the scored agents and the scored tools. In this aspect, additionally or alternatively, the one or more generated tools may include a root cause analysis tool.

Another aspect provides a computing method for generating an agentic system, the computing method comprising receiving a request including natural language text input from an interaction interface, generating an agent design prompt including an agent task description, agent output instructions, and scored agents based on the request, inputting the agent design prompt into an agent design generator to generate one or more agents, generating a tool design prompt including the one or more generated agents, a tool task description, tool output instructions, and scored tools, inputting the tool design prompt into a tool generator to generate one or more tools, and generating and output the agentic system including the one or more generated agents and the one or more generated tools. In this aspect, additionally or alternatively, the method may further comprise generating a critic prompt including the one or more generated agents, the one or more generated tools, and a critic task description, and inputting the critic prompt into a critic agent to generate one or more suggestions. In this aspect, additionally or alternatively, the method may further comprise determining whether to regenerate the one or more agents and the one or more tools based on predetermined criteria. In this aspect, additionally or alternatively, upon determining to regenerate the one or more agents and the one or more tools the tool design prompt may be regenerated to include the one or more suggestions, the tool task description, the tool output instructions, and the scored tools, and input the tool design prompt into the tool generator to regenerate the one or more tools, and the agent design prompt may be regenerated to include the one or more suggestions, the agent task description, agent output instructions, and the scored agents, and input the agent design prompt into the agent design generator to regenerate the one or more agents. In this aspect, additionally or alternatively, the method may further comprise generating an evaluation for the agentic system, and determining whether the evaluation for the agentic system meets predetermined evaluation criteria. In this aspect, additionally or alternatively, the predetermined evaluation criteria may include predetermined thresholds for quantitative evaluation scores or a number of iterations reached in generating the agentic system. In this aspect, additionally or alternatively, upon determining that the evaluation for the agentic system does not meet the predetermined evaluation criteria the agent design prompt may be regenerated to include the generated evaluation, the agent task description, the agent output instructions, and the scored agents, and the agent design prompt may be inputted into the agent design generator to regenerate the one or more agents. In this aspect, additionally or alternatively, upon determining that the evaluation for the agentic system meets the predetermined evaluation criteria, the agentic system may be outputted and the agentic system may be incorporated into an adaptive agent archive comprising the scored agents and the scored tools.

Another aspect provides a computing system for generating an agentic system, the computing system comprising processing circuitry and memory storing instructions that, when executed by the processing circuitry, cause the processing circuitry to receive a request, generate an agent design prompt based on the request, input the agent design prompt into an agent design generator to generate one or more agents, generate an evaluation for the one or more agents, determine whether the evaluation for the agentic system meets predetermined evaluation criteria, upon determining that the evaluation for the one or more agents does not meet the predetermined evaluation criteria, regenerate the agent design prompt, and input the agent design prompt into the agent design generator to regenerate the one or more agents, upon determining that the evaluation for the one or more agents meets the predetermined evaluation criteria, generate and output the one or more generated agents, the predetermined evaluation criteria including predetermined thresholds for quantitative evaluation scores. In this aspect, additionally or alternatively, the one or more agents may include a generic agent with no additional tool allocations or capabilities, and when the one or more agents may be regenerated, additional tool allocations and/or capabilities may be added to the generic agent.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating an agentic system, the computing system comprising:
processing circuitry and memory storing instructions that, when executed by the processing circuitry, cause the processing circuitry to:
receive a request including natural language text input from an interaction interface;
generate an agent design prompt including an agent task description, agent output instructions, and scored agents based on the request;
input the agent design prompt into an agent design generator to generate one or more agents;
generate a tool design prompt including the one or more generated agents, a tool task description, tool output instructions, and scored tools;
input the tool design prompt into a tool generator to generate one or more tools; and
generate and output the agentic system including the one or more generated agents and the one or more generated tools.

2. The computing system of claim 1, wherein the instructions are further configured to be executed to generate a critic prompt including the one or more generated agents, the one or more generated tools, and a critic task description, and to input the critic prompt into a critic agent to generate one or more suggestions.

3. The computing system of claim 2, wherein the instructions are further configured to be executed to determine whether to regenerate the one or more agents and the one or more tools based on predetermined criteria.

4. The computing system of claim 3, wherein the predetermined criteria are selected from the group consisting of a number of critic prompts used, and a content of the one or more suggestions.

5. The computing system of claim 4, wherein, upon determining to regenerate the one or more agents and the one or more tools, the instructions are further configured to be executed to:
regenerate the tool design prompt including the one or more suggestions, the tool task description, the tool output instructions, and the scored tools, and input the tool design prompt into the tool generator to regenerate the one or more tools; and
regenerate the agent design prompt including the one or more suggestions, the agent task description, agent output instructions, and the scored agents, and input the agent design prompt into the agent design generator to regenerate the one or more agents.

6. The computing system of claim 1, wherein the instructions are further configured to be executed to:
generate an evaluation for the agentic system; and
determine whether the evaluation for the agentic system meets predetermined evaluation criteria.

7. The computing system of claim 6, wherein the predetermined evaluation criteria includes predetermined thresholds for quantitative evaluation scores or a number of iterations reached in generating the agentic system.

8. The computing system of claim 7, wherein, upon determining that the evaluation for the agentic system does not meet the predetermined evaluation criteria, the instructions are further configured to be executed to regenerate the agent design prompt including the generated evaluation, the agent task description, the agent output instructions, and the scored agents, and input the agent design prompt into the agent design generator to regenerate the one or more agents.

9. The computing system of claim 7, wherein, upon determining that the evaluation for the agentic system meets the predetermined evaluation criteria, the instructions are further configured to output the agentic system and incorporate the agentic system into an adaptive agent archive comprising the scored agents and the scored tools.

10. The computing system of claim 1, wherein the one or more generated tools includes a root cause analysis tool.

11. A computing method for generating an agentic system, the computing method comprising:
receiving a request including natural language text input from an interaction interface;
generating an agent design prompt including an agent task description, agent output instructions, and scored agents based on the request;
inputting the agent design prompt into an agent design generator to generate one or more agents;
generating a tool design prompt including the one or more generated agents, a tool task description, tool output instructions, and scored tools;
inputting the tool design prompt into a tool generator to generate one or more tools; and
generating and output the agentic system including the one or more generated agents and the one or more generated tools.

12. The computing method of claim 11, further comprising:
generating a critic prompt including the one or more generated agents, the one or more generated tools, and a critic task description; and
inputting the critic prompt into a critic agent to generate one or more suggestions.

13. The computing method of claim 12, further comprising determining whether to regenerate the one or more agents and the one or more tools based on predetermined criteria.

14. The computing method of claim 13, wherein, upon determining to regenerate the one or more agents and the one or more tools:
the tool design prompt is regenerated to include the one or more suggestions, the tool task description, the tool output instructions, and the scored tools, and input the tool design prompt into the tool generator to regenerate the one or more tools; and
the agent design prompt is regenerated to include the one or more suggestions, the agent task description, agent output instructions, and the scored agents, and input the agent design prompt into the agent design generator to regenerate the one or more agents.

15. The computing method of claim 11, further comprising:
generating an evaluation for the agentic system; and
determining whether the evaluation for the agentic system meets predetermined evaluation criteria.

16. The computing method of claim 15, wherein the predetermined evaluation criteria include predetermined thresholds for quantitative evaluation scores or a number of iterations reached in generating the agentic system.

17. The computing method of claim 16, wherein, upon determining that the evaluation for the agentic system does not meet the predetermined evaluation criteria:
the agent design prompt is regenerated to include the generated evaluation, the agent task description, the agent output instructions, and the scored agents; and
the agent design prompt is inputted into the agent design generator to regenerate the one or more agents.

18. The computing method of claim 16, wherein, upon determining that the evaluation for the agentic system meets the predetermined evaluation criteria, the agentic system is outputted and the agentic system is incorporated into an adaptive agent archive comprising the scored agents and the scored tools.

19. A computing system for generating an agentic system, the computing system comprising:
processing circuitry and memory storing instructions that, when executed by the processing circuitry, cause the processing circuitry to:
receive a request;
generate an agent design prompt based on the request;
input the agent design prompt into an agent design generator to generate one or more agents;
generate an evaluation for the one or more agents;
determine whether the evaluation for the agentic system meets predetermined evaluation criteria;
upon determining that the evaluation for the one or more agents does not meet the predetermined evaluation criteria, regenerate the agent design prompt, and input the agent design prompt into the agent design generator to regenerate the one or more agents;
upon determining that the evaluation for the one or more agents meets the predetermined evaluation criteria, generate and output the one or more generated agents, wherein
the predetermined evaluation criteria include predetermined thresholds for quantitative evaluation scores.

20. The computing system of claim 19, wherein
the one or more agents include a generic agent with no additional tool allocations or capabilities; and
when the one or more agents are regenerated, additional tool allocations and/or capabilities are added to the generic agent.
